(19) United States
(12) Patent Application Publication
(10) Pub. No.: US 2008/0307079 A1
(43) Pub. Date: Dec. 11, 2008

(54) Apparatus and Method For Managing Addresses of Network Elements

(75) Inventors: Jeong Hyun Choi, Seoul (KR); Sung Joon Ahn, Kyunggi-do (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC., Seoul (KR)

(21) Appl. No.: 11/572,855

(22) PCT Filed: Oct. 14, 2004
(86) PCT No.: PCT/KR04/02624

§ 371 Date: Jul. 14, 2008

(30) Foreign Application Priority Data
Jul. 30, 2004 (KR) 10-2004-0060420

(51) Int. Cl. G06F 15/173

(52) U.S. Cl. 709/223

(57) ABSTRACT

The present invention relates apparatus and method for managing addresses of network elements connected to a network. An IGD (Internet Gateway Device) of the present invention comprises a WAN device conducting gateway function of a home network or other network, and a LAN device that communicates with the WAN device and has address management information used for management of a 16-byte-long IPv6 addresses to be assigned to the element. The address management information is set or read by a command received from a remote element on the network in which a control application is running.

### 1. TECHNICAL FIELD

The present invention relates to apparatus and method for managing addresses of network elements connected to a network, especially a home network.

### 2. BACKGROUND ART

As high-end digital audio/video electronic appliances such as DVD players and personal computers (PCs) get spread to almost every household, there have been demands for communication between the electronic appliances as well as communication between the appliances with an outside network. Furthermore, there has been the demand for consumers to hope to control the many home appliances with a mobile apparatus such as personal direct access (PDA).

To satisfy the demands, there have been researches on a home network through which digital home appliances such as DVD players and digital TVs can be connected to each other. The universal plug and play (UPnP) technology has been proposed as a promising home network. According to UPnP standards, one server is required to form a home network. The function of the server is to assign addresses of nodes or network elements connected to the home network and in addition, to perform gateway function of the home network to other networks. The server is called Internet gateway device (IGD) and is implemented as a stand-alone apparatus or in other electronic appliances like a PC and digital TV.

On the other hand, a network element is identified uniquely by a 4-byte-long IP address on the Internet based on the Internet protocol version 4 (IPv4). A new Internet protocol version 6 (IPv6) that uses 16-byte-long address system has been proposed to deal with the explosive growth of network elements connected to the Internet. Since it is desirable that an IGD communicates with the outside network based on the IPv6-based protocol, an IGD should be able to assign or allocate IPv6-based addresses to network elements such as electronic consumer appliances and information appliances connected to a home network.

### 3. DISCLOSURE OF THE INVENTION

It is an object of the present invention to provide apparatus and method for managing IPv6-based addresses of the network elements connected to a home network.

It is another object of the present invention to provide apparatus and method of setting and reading IPv6-based address management information for home networking.

In accordance with the present invention, a device conducting gateway function of a home network to other networks has address management information that is required to manage allocation of network addresses longer then 4 bytes to network elements connected to the home network.

The address management information is read and set by commands received from a remote element on the home network.

The remote commands are produced and sent by a control application that is running on a remote element on the home network.

In one embodiment of the present invention, IPv6-based 16-byte-long addresses are used and the remote element in which a control application runs is a PDA or PC.

In another embodiment of the present invention, the address management information defines a range of addresses assignable to the network elements connected to the home network by designating the maximum and minimum of assignable addresses.

In another embodiment of the present invention, the address management information includes a prefix of addresses assigned to the network elements connected to the home network and a period of validity of the prefix.

In another embodiment of the present invention, the address management information is organized separately for managing allocation of addresses in a plurality of home networks.

### 4. BRIEF DESCRIPTION OF THE DRAWINGS

FIG. 1 is a block diagram of an IGD in accordance with the present invention;

FIG. 2 shows an address management information table for management of allocation of IPv6-based addresses in accordance with one embodiment of the present invention;

FIG. 3 is a view showing a procedure of reading and setting state variables in the address management information table through a home network;

FIG. 4 shows an address management information table for management of allocation of IPv6-based addresses in accordance with another embodiment of the present invention;

FIG. 5 is a view showing that an IPv6-based address is assigned to an element on a home network automatically in the embodiment of FIG. 4;

FIG. 6 shows an extended structure of the address management information table of FIG. 2 for a plurality of subnets (home networks); and

FIG. 7 shows an extended structure of the address management information table of FIG. 4 for a plurality of subnets (home networks).

### 5. BEST MODE FOR CARRYING OUT THE INVENTION

In order that the invention may be fully understood, preferred embodiments thereof will now be described with reference to the accompanying drawings.

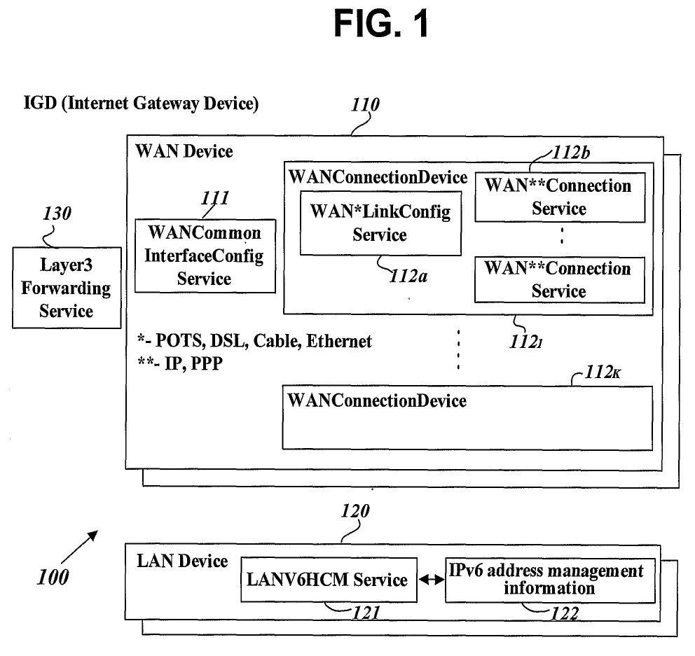

FIG. 1 shows a conceptual block diagram of an IGD in accordance with the present invention. The IGD comprises a WAN device 110, a LAN device 120, and a routing service unit 130.

The WAN device 110 comprises a WANCommonInterfaceConfigService unit 111 for setting common communication environment variables of connectivity to a wide area network (WAN); and a plurality of WAN Connection Device 112k for WAN connectivity, each consisting of a WANLinkConfigService 112a for setting connectivity environment variables of WAN links such as cables or Ethernet; and at least one WANConnectionService unit 112b for making virtual connections on the WAN links and providing a communication service to other network via the virtual connection. The WAN device 110 provides gateway function to other networks like the Internet.

The LAN device 120 comprises a LAN IPv6 host configuration management (LANV6HCM) service unit 121 for performing management of IPv6-based addresses of the network elements connected to a home network; and IPv6 address management information 122 that is referenced by the LANV6HCM service unit 120. Moreover, the LAN device 120 may provide hub function of the home network by further including ports through which all network elements are inter-connected physically.

The routing service unit 130 routes a message to its proper connection channel depending on the destination of the message. Messages sent from a home network to the outside network are received by the LAN device 120 and are then sent to the outside network via the WAN device 110.

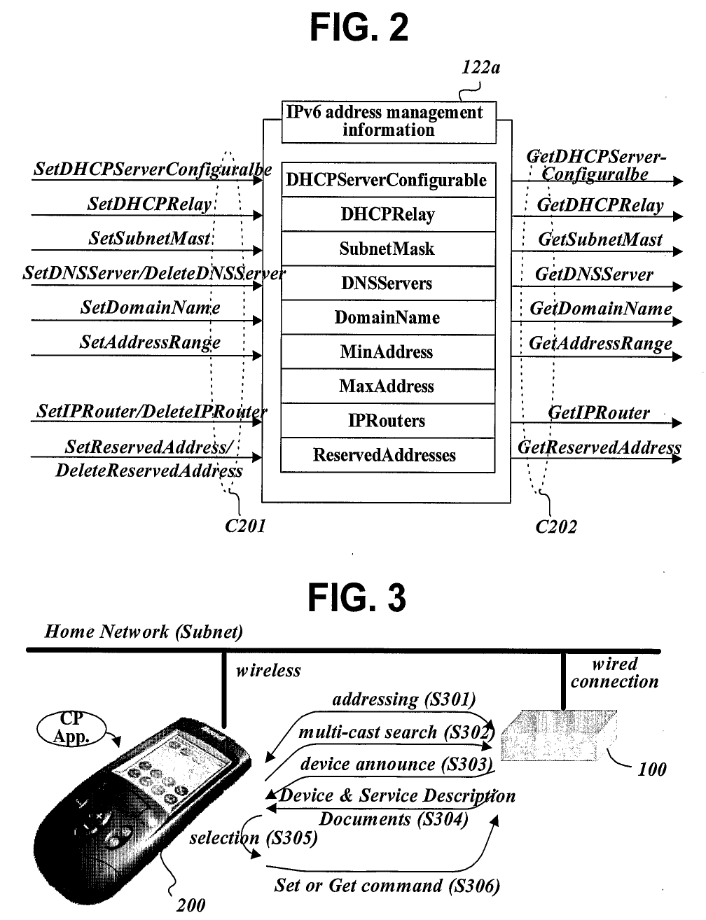

FIG. 2 is a view showing a table of IPv6 address management information 122 and the process of setting and reading state variables of IPv6 address management information 122 by commands from a remote network element on a home network in accordance with one embodiment of the present invention. As shown in FIG. 2, the IPv6 address management information table 122a includes state variables of DHCPServerConfigurable, DHCPRelay, SubnetMask, DNSServers, DomainName, MinAddress, MaxAddress, IPRouters, and ReservedAddress. The DHCPServerConfigurable variable indicates whether allocation of IPv6-based addresses is conducted by an outside DHCPv6 server or by the LANV6HCM service unit 121. The DHCPRelay variable indicates if or not a request to allocation of IPv6-based address is relayed to another server. When the request is relayed to a higher level, the destination of the request message is changed into the address of a server on the higher level before the message is resent.

The SubnetMask variable has a masking value that masks upper bits of IPv6-based address. The part of an IPv6-based address masked by the SubnetMask is an identifier of a subnetwork. The DNSservers variable is a list of addresses of DNSv6 servers that provide domain name system (DNS) service, and the DomainName variable represents the domain name of network elements on the home network.

The MinAddress and MaxAddress variables indicate a range of IPv6-based addresses that are assignable to network elements on the home network. The LANV6HCM service unit 121 assigns an IPv6-based address to a network element on the home network based on The MinAddress and MaxAddress variables.

The IPRouters variable represents an address of the IGD 100 itself if there is no extra router or gateway on the home network. Otherwise, the IPRouters variable represents an address of the extra router. The IPRouters variable is distributed to all network elements on the home network. The ReservedAddresses variable includes a list of reserved IPv6-based addresses.

The IPv6 address management information table 122a is set or read by electronic devices with display such as a PDA and notebook computer on which a control point (CP) application is running. FIG. 3 is a brief view showing the process of setting and reading state variables in the address management information table 122a in a home network.

When a device on which a CP application is running, for example, PDA 200 becomes connected, by wire or wireless means, to a home network equipped with an IGD 100, the addressing step (S301) is executed to request an IPv6-based address. In the S301 step, an address is chosen among non-assigned addresses in a range of assignable addresses that are designated by the MinAddress and MaxAddress variables by the LANV6HCM service unit 121 and is then sent to the PDA 200, together with state variables of SubnetMask, DNSservers, DomainName, and IPRouters in the IPv6 address management information table 122a. As long as the PDA 200 is connected to the home network, the address assigned to the PDA 200 will not be assigned to other elements by marking and storing the address as assigned one.

If the addressing step is completed, CP application broadcasts a Multicast search message on the home network (S302) In response to the search message, all elements on the network reply their own Device Announcement messages that include their own identities, capacities, and so on (S303). In this way, the CP application detects all live UPnP elements on the home network.

On the other hand, the IGD 100 provides the CP application with either an executable document for example, an extensible markup language (XML)-formatted description document that includes the description and information that is required to invoke its own functions, or address information from which the executable document is accessible (S304). The description document comprises descriptions on commands for setting/adjusting/reading state variables in the IPv6 address management information table 122a. The CP application can execute a graphic user interface suited for the IGD 100 by using the description document.

If a user chooses the IGD 100 among the elements on the home network (S305), the CP application receives the description document from the IGD 100, interprets it, and displays a menu screen on which commands for resetting and reading the state variables in the IPv6 address management information table 122a are provided. For example, set command (C201) and get command (C202) for each entry in the IPv6 address management information table 122a are provided on the menu screen. Data accompanying with a set command is entered on a keypad on the PDA 200. By using set commands, the state variables of the IPv6 address management information table 122a stored in the IGD 100 can be reset from initial default values to new values adequate to access of other network like Internet.

Moreover, the description document is composed such that, in addition to set commands, delete commands are also executed for the state variables of DNSServers, IPRouters, and ReservedAddresses.

In the manner described above, the IPv6 address management information table 122 in the IGD 100 can be read and set by a remote element on the home network.

On the other hand, based on basic information and the description documents that are received from the elements on the home network through the same step as the S303 step, the CP application can conduct remote controls of functions of the elements such as a DVD player.

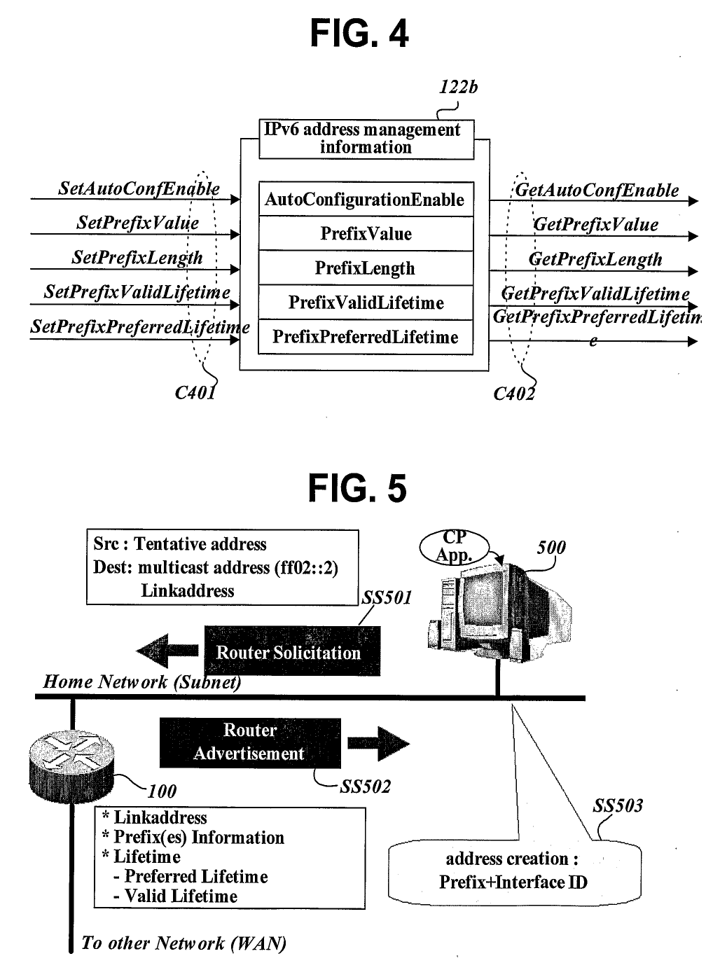

FIG. 4 is a view showing a table of IPv6 address management information 122 and the process of setting and reading IPv6 address management information 122 by commands from a remote network element on the home network in accordance with another embodiment of the present invention. As shown in FIG. 4, the IPv6 address management information table 122b includes state variables of AutoconfigurationEnable, PrefixValue, PrefixLength, PrefixValidLifetime, and PrefixPreferredLifetime.

The AutoconfigurationEnable variable indicates whether automatic allocation of IPv6-based addresses is enabled or not. The PrefixValue variable represents the prefix of a subnetwork where IPv6-based addresses are managed by the LANV6HCM service unit 121, and the PrefixLength variable represents the length of the PrefixValue.

The PrefixValidLifetime and PrefixPreferredLifetime variables represent the period of validity of an IPv6-based address. The PrefixPreferredLifetime variable indicates the lifetime of an allocated IPv6-based address while the PrefixValidLifetime variable indicates a valid time of a connection made using an allocated IPv6-based address. Therefore, if the lifetime designated by PrefixValidLifetime variable expires during the lifetime designated by PrefixPreferredLifetime variable, new IPv6 connections no longer establishes while a communication on the existing IPv6-based connections is still possible.

As in the IPv6 address management information table 112a of FIG. 2, the state variables in the IPv6 address management information table 122b are set or read by electronic devices with display such as a PDA and notebook computer on which a CP application is running according to the procedure described in FIG. 3.

When a device on which a CP application running, for example, a PDA becomes connected, by wire or wireless means, to a home network equipped with an IGD 100, the addressing step (S301) is executed to request an IPv6-based address. FIG. 5 is a brief view showing the addressing step in case that a CP application runs on a PC 500.

The PC 500 sends a request of getting the prefix information corresponding to the subnet to which the IGD 100 belongs by multi-casting Router Solicitation message on the subnet according to Neighbor Discovery (ND) protocol in the IPv6 standards (SS501).

In response to the request, the LANV6HCM service unit 121 sends Router Advertisement message to the PC 500 based on the IPv6 address management information table 122b (SS502). The Router Advertisement message includes the prefix information (PrefixValue and PrefixLength), the prefix lifetime information (PrefixValidLifetime and PrefixPreferredLifetime), and a link address included in the Router Solicitation message. After receiving the Router Advertisement message, the LAN adaptor of the PC 500 produces its unique IPv6 address by using the prefix information and an interface identifier, for example, a unique media access control (MAC) address assigned to the LAN adaptor (SS503).

The prefix that is sent from the LANV6HCM service unit 121 is, desirably, 8 bytes long in order to avoid an overlap between the prefix and the MAC address that would happen because it is expected that the MAC address is lengthened from 6 bytes to 8 bytes. Hence, the LAN adaptor of the PC 500 uses its unique 16-byte-long IPv6 address on the subnet by combining the prefix and its MAC address as the upper 8 bytes and the lower 8 bytes, respectively.

Instead of assigning an IPv6 address to network elements on the home network one-to-one, the LANV6HCM service unit 121 assigns just the prefix of 8 bytes to each network element so that each element generates its unique IPv6 address by itself. Therefore, no extra storage of all the assigned IPv6 addresses is required to avoid allocation of duplicate IPv6 addresses.

After the addressing step is completed, the same steps of S302 through S304 as those of FIG. 3 are executed. A user can choose the IGD 100 among the elements on the home network and set or read the state variables in the IPv6 address management information table 122b by using set command (C410) and get command (C402).

The set and get commands may be provided for each state variable. Data accompanying with a set command is entered on a keyboard of the PC 500. By using set commands, the state variables of the IPv6 address management information table 122b stored in the IGD 100 can be set from initial default values to new values adequate to access of other network such as Internet.

Furthermore, the IGD 100 can have a plurality of subnets. In the case, one IPv6 address management information 122 is provided for each subnet.

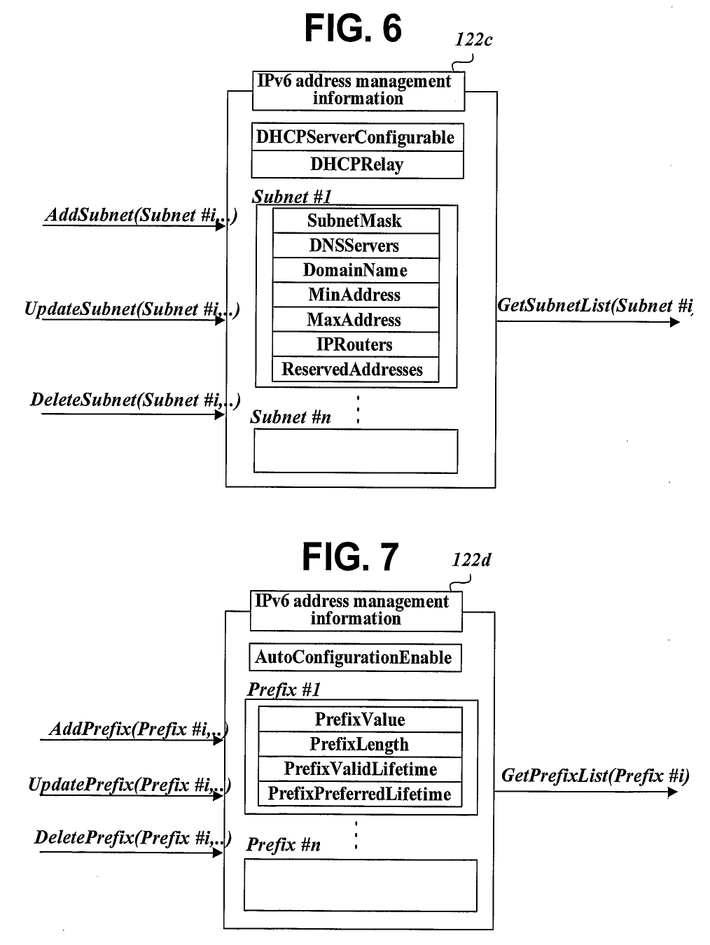

FIG. 6 is a view showing an IPv6 address management information table 122c or an extension of the table of FIG. 2 supporting for a plurality of subnets. FIG. 7 is a view showing an IPv6 address management information table 122d or an extension of the table of FIG. 4 for supporting a plurality of subnets.

As shown in the table of FIG. 6, the table includes state variables of DHCPServerConfigurable and DHCPRelay for the entire subnets and address information table entries (Subnet #1, #2, . . . , #n), each table entry including state variables of SubnetMask, DNSServers, DomainName, MinAddress, MaxAddress, IPRouters, and ReservedAddress.

Commands are available to individually add/update/delete/get state variables of a designated subnet: AddSubnet(Subnet #i, . . . ), UpdateSubnet(Subnet #i, . . . ), DeleteSubnet(Subnet #i, . . . ), and GetSubnetList(Subnet#i).

Of course, these commands are requested from a remote network element on which a CP application is running, for example, a PC or PDA to the IGD 100 through the home network. A text or graphic user interface that enables the request of these commands is defined and implemented in a description document supplied from the IGD 100.

In the embodiment of FIG. 7, the IPv6 address management information table includes a single state variable of AutoconfigurationEnable for the entire subnets and address information table entries (Prefix #1, #2, . . . , #n), each table entry including state variables of PrefixValue, PrefixLength, PrefixValidLifetime, and PrefixPreferredLifetime.

Likewise, commands are available to individually add/update/delete/get state variables of a designated subnet: AddPrefix(Prefix #i, . . . ), UpdatePrefix(Prefix #i, . . . ), DeletePrefix(Prefix #i, . . . ), and GetPrefixList(Prefix #i).

These commands are also requested from a remote network element on which a CP application is running to the IGD 100 through the home network.

On the other hand, commands that are provided separately by state variable, as in the foregoing embodiments, may be represented by a common function and its first command object parameter. For example, set commands in the embodiment of FIG. 4 (SetAutoConfEnable, SetPrefixValue, SetPrefixLength, SetPrefixValidLifetime, and SetPrefixPreferredLifetime) may be defined as Set(0, . . . ), Set(1, . . . ), Set (2, . . . ), Set(3, . . . ), and Set(4, . . . ). Likewise, get commands in the embodiment of FIG. 4 (GetAutoConfEnable, GetPrefixValue, GetPrefixLength, GetPrefixValidLifetime, and GetPrefixpreferredLifetime) may be defined as Get(0, . . . ), Get(1, . . . ), Get (2, . . . ), Get (3, . . . ), and Get (4, . . . ).

The description document may be made by the IGD 100 according to the new definitions of set/get commands. Commands in the form of Set(command object, . . . ) or Get(command object, . . . ) are sent to the LANV6HCM service unit 121 in the LAN device 120 through the execution of the document by a CP application. In response to the commands, the LANV6HCM service unit 121 selects a proper state variable designated by the received command object parameter and performs a designated function to the selected state variable.

Instead of providing set commands and get commands separately, they may be represented by a single command name, for example “InterfaceCommand”. In this case, whether the command is set or “get” is identified by either an extended command object parameter or a new command type parameter.

The present invention, disclosed with respect to a limited number of embodiments, enables to provide a convenient way of allocation of IPv6-based 16-byte-long address to electronic appliances connected to a home network by utilizing a new network address system.

1. An apparatus for managing network addresses of network elements on a network, comprising
a device having address management information used for allocation management of network address longer than 4 bytes to be assigned to the network elements, the device setting variables in the address management information or sending information indicative of the set variables in response to a received set or read command.

2. The apparatus as set forth in claim 1, wherein the network address is 16 byte-long address defined by Internet protocol version 6 (IPv6).

3. The apparatus as set forth in claim 1, wherein the received command is defined in a description document that is provided to the network elements on the network by the apparatus.

4. The apparatus as set forth in claim 3, wherein the description document is written in a markup language.

5. The apparatus as set forth in claim 1, wherein the received command is sent by an application running on a first network element on the network.

6. The apparatus as set forth in claim 5, wherein the application searches for other network elements connected to the network if the first network element is connected to the network and receives a network address.

7. The apparatus as set forth in claim 5, wherein the variables in the address management information are set based on values that are inputted to the application through an input means of the first network element.

8. The apparatus as set forth in claim 1, wherein the address management information includes a variable indicating whether or not allocation of an address is performed by a server on the other network, a variable indicating whether or not a request to allocation of an address is relayed to a higher level, a masking value to mask upper bits of the network address, a DNS server address, a domain name of network elements on the network, variables indicating a range of assignable addresses, an address of the router on the network, and reserved addresses.

9. The apparatus as set forth in claim 8, wherein, in a process of assigning an address to one network element, the device selects an address among non-assigned addresses in the range of assignable addresses and then sends the address to the network element, together with at least the masking value, the DNS server address, the domain name, and the router address.

10. The apparatus as set forth in claim 8, wherein the address management information comprises a plurality of address management information tables, each table including a masking value, a DNS server address, a domain name, a range of assignable addresses, a router address, and reserved addresses.

11. The apparatus as set forth in claim 10, wherein the plurality of address management information tables are individually added, updated, deleted, and read by the received command.

12. The apparatus as set forth in claim 1, wherein the address management information includes a variable indicating whether an automatic assignment of addresses is enabled or not, an address prefix of the network, a length of the prefix, and a valid time of the prefix.

13. The apparatus as set forth in claim 12, wherein, in a process of assigning an address to one network element, the device sends at least the prefix and the valid time of the prefix to the network element.

14. The apparatus as set forth in claim 12, wherein the address management information comprises a plurality of address management information tables, each table including a prefix of the network, a length of the prefix, and a valid time of the prefix.

15. The apparatus as set forth in claim 14, wherein the plurality of address management information tables are individually added, updated, deleted, and read by the received command.

16. The apparatus as set forth in claim 1, wherein the received command is identified as set or read command by command name.

17. The apparatus as set forth in claim 1, wherein the received command has the same name for set and read command but is identified as set or read command by a command parameter.

18. The apparatus as set forth in claim 1, wherein the network is a home network to which home electronic appliances such as a DVD player and digital TV are connected.

19. The apparatus as set forth in claim 1, wherein the set or read command is received from a remote network element connected to the network.

20. The apparatus as set forth in claim 1, further comprising a second device, communicating with the device, conducting gateway function of the network to other network.

21. An address managing method conducted by an apparatus of managing network addresses of network elements on a network, comprising the steps of:
receiving a set or read command that requests to set or read variables of address management information, the address management information being used for allocation management of network address longer than 4 bytes to be assigned to the network elements; and
setting variables in the address management information or sending information indicative of the variables in response to the received set or read command.

22. The method as set forth in claim 21, wherein the network address is 16-byte-long address defined by Internet protocol version 6 (IPv6).

23. The method as set forth in claim 21, wherein the received command is defined in a description document that is provided to the network elements on the network by the apparatus.

24. The method as set forth in claim 23, wherein the description document is written in a markup language.

25. The method as set forth in claim 21, wherein the received command is sent by an application running on one network element on the network.

26. The method as set forth in claim 25, wherein, in response to element searching operation of the application, before the receiving step, the apparatus provides the application with its identification information and either a description document or an address information by which the description document is accessible.

27. The method as set forth in claim 21, wherein the address management information includes a variable indicating whether or not allocation of an address is performed by a server on the other network, a variable indicating whether or not a request to allocation of an address is relayed to a higher level, a masking value to mask upper bits of the network address, a DNS server address, a domain name of network elements on the network, variables indicating a range of assignable addresses, an address of the router on the network, and reserved addresses.

28. The method as set forth in claim 27, further comprising a step of assigning an address to one network element, wherein in the assigning step, an address is chosen among non-assigned addresses in the range of assignable addresses and is then sent to the network element, together with at least the masking value, the DNS server address, the domain name, and the router address.

29. The method as set forth in claim 27, wherein the address management information comprises a plurality of address management information tables, each table including a masking value, a DNS server address, a domain name, a range of assignable addresses, a router address, and reserved addresses.

30. The method as set forth in claim 29, wherein the plurality of address management information tables are individually added, updated, deleted, and read by the received command.

31. The method as set forth in claim 21, wherein the address management information includes a variable indicating whether an automatic assignment of addresses is enabled or not, an address prefix of the network, a length of the prefix, and a valid time of the prefix.

32. The method as set forth in claim 31, further comprising a step of assigning an address to one network element, wherein in the assigning step, at least the prefix and the valid time of the prefix are sent to the network element.

33. The method as set forth in claim 31, wherein the address management information comprises a plurality of address management information tables, each table including a prefix of the network, a length of the prefix, and a valid time of the prefix.

34. The method as set forth in claim 33, wherein the plurality of address management information tables are individually added, updated, deleted, and read by the received command.

35. The method as set forth in claim 21, wherein the received command is identified as set or read command by command name.

36. The method as set forth in claim 21, wherein the received command has the same name for set and read command but is identified as set or read command by a command parameter.

37. The method as set forth in claim 21, wherein the network is a home network to which home electronic appliances such as a DVD player and digital TV are connected.

38. The method as set forth in claim 21, wherein the set or read command is received from a remote network element connected to the network.
